(19) United States
(12) Patent Application Publication
(10) Pub. No.: US 2011/0035339 A1
(43) Pub. Date: Feb. 10, 2011

(54) Body Type Based Line of Clothing and Method of Selling Same

(76) Inventor: Tina Wilson, New York, NY (US)

Correspondence Address: Law Office of Michael J. Feigin, 103 The Circle, (http://PatentLawNY.com), Passaic, NJ, 07055, US

(21) Appl. No.: 12/535,748

(22) Filed: Aug. 5, 2009

(51) Int. Cl. G06Q 99/00; A41D 1/00

(52) U.S. Cl. 705/500; 2/69

(57) ABSTRACT

Embodiments of the technology disclosed herein comprise a line of clothing (e.g., a collection of shirts, undergarments, combination thereof, etc.). Within the line of clothing are various styles of clothing (e.g., various types of shirts, undergarments, etc). Each style of clothing further comprises at least two selections of body type for different shaped bodies within a size designation. Such body types may be an apple, pear, hourglass, or banana body type for which garments of a particular style are manufactured and sold to more accurately and predictably fit a wearer.

### BACKGROUND OF THE INVENTION

The clothing industry, in general, manufactures and sells clothing based on a general production model by which garments are sold by size, which is a rough approximation of the overall dimensions of any given wearer. While individually tailored clothing is expensive, the general sizing scheme known in the art leaves many people uncomfortable in their off-the-shelf clothing purchases. Making clothing that fits people based on their size fails to take into account the unique attributes of a person, such as the unique (proportions of each one's body.

Still further, clothes are almost always tried on before purchase. The need to try on clothing and, where applicable, the need to get clothing altered to fit, is time-consuming. The practice of numerous people, in turn, trying on an item wears the clothes down, and is unhygienic. Still further, online commerce (the selling of clothing via a website) and catalog sales are inhibited, since it is difficult for a purchaser to gauge whether a garment will fit properly based on viewing a picture alone.

Still further, standard clothing sizes known in the art inhibit buying gift purchases for another person. For example, a woman may know that a particular line of clothing or style of clothing fits her well, but her husband will likely be ignorant of such data. He may know her size, but size information is simply not enough in many cases to ascertain if a garment will fit the intended wearer. Thus, the husband is less likely to purchase clothing for his wife and/or the garment is more likely to be returned or exchanged, causing excess wear on the garment and lost time on the part of the merchant, purchaser, and potential wearer.

What is needed in the art is a clothing design and/or method which decreases shopping time and consumer dissatisfaction with clothing items due to poor fit. Clothing which reliably fits individuals better, while retaining the advantage of being mass producible is needed.

### SUMMARY OF THE DISCLOSED TECHNOLOGY

An object of the disclosed technology is to provide clothing that is offered with selections in style, size, and body type.

The disclosed technology may have at least, but not be limited to, two selections in style. Of these selections, there may be, at a minimum, two sizes to choose from for each style. Of these selections in size, there may be at least two selections in body type offered from the line of clothing. This selection of body types may be four body types, such as apple, pear, hourglass, and banana, as are further defined based on the definitions provided by the inventor in the detailed description of embodiments of the disclosed technology. The four variations of body types encompass most or almost all individuals.

More specifically, the first one of the body types being offered may be wider in the bust area than the other body types. The second may have a longer and smaller waist than the first body type and have a fuller bottom than the other body types.

A method for manufacturing disclosed in embodiments of the disclosed technology may be the manufacture of a minimum of two styles of clothing, each of these two styles manufactured in at least two sizes, and each of the sizes manufactured for at least two body types.

At least two body types, in the above embodiment, may be four or five body types. The four body types may be any one of a selection of apple, pear, hourglass, and/or banana. The method disclosed may have a first body type comprising a wider opening at the bust than the other body types. The second body type may comprise a longer and smaller waist than the first body type, and it may be manufactured to have a fuller bottom than the other body types.

The line of clothing disclosed may have at least two styles. Of these styles, a line might have a minimum of two sizes for each of the styles, and the line disclosed may offer two or more body types for each of the styles and each of the sizes. The body sizes may be selected from the categories of apple, pear, hourglass, and banana.

The line of clothing disclosed may consist of four body types. The line of clothing may have the first body type comprise a wider opening at the bust than the other body types. The second body type may have a longer and smaller waist than the first body type, and it may also comprise a fuller bottom than the other body types.

Articles of clothing designed in an identical style and which are the same size, may have at least three different body types, where the first body type may have a wider opening at the bust than the other body types, and it may also have a shorter and wider waist than two or more of the other body types. The second body type may have a longer and smaller waist than the first body type, while it may also have a fuller bottom than the other body types. The number of body types designed may be four types, and they may consist of the types: apple, pear, hourglass, and banana.

Further details are set forth in the detailed description below.

### BRIEF DESCRIPTION OF THE DRAWINGS

FIG. 1 shows a high level chart of a prior art method for offering a line of clothing for sale based on size.

FIG. 2 shows a high level chart of a method of offering a line of clothing for sale based on size and body type in embodiments of the disclosed technology.

FIG. 3 shows a chart of body type features for garments in a line of clothing in embodiments of the disclosed technology.

FIG. 4 shows a chart of body type firmness for garments in a line of clothing in embodiments of the disclosed technology.

FIG. 5A is a drawing of a front view of a garment comprising an apple body type in an embodiment of the disclosed technology.

FIG. 5B is a drawing of a back view of a garment comprising an apple body type in an embodiment of the disclosed technology.

FIG. 6A is a drawing of a back, side view of a garment comprising an apple body type in an embodiment of the disclosed technology.

FIG. 6B is a drawing of a front, side view of a garment comprising an apple body type in an embodiment of the disclosed technology.

FIG. 7A is a drawing of a front view of a garment comprising a pear body type in an embodiment of the disclosed technology.

FIG. 7B is a drawing of a back view of a garment comprising a pear body type in an embodiment of the disclosed technology.

FIG. 8A is a drawing of a front, side view of a garment comprising a pear body type in an embodiment of the disclosed technology.

FIG. 8B is a drawing of a back, side view of a garment comprising a pear body type in an embodiment of the disclosed technology.

FIG. 9 shows an example of a method of sale of a clothing style comprising a body type selection in an embodiment of the disclosed technology.

### DETAILED DESCRIPTION OF EMBODIMENTS OF THE DISCLOSED TECHNOLOGY

An embodiment of the disclosed technology comprises a line of clothing (e.g., a collection of shirts, undergarments, combination thereof, etc.), and within the line of clothing are various styles of clothing (e.g., shirts, undergarments, etc., as are further defined below). Each style of clothing further comprises at least two selections of body type (e.g., for differently shaped bodies within a size designation).

A style of clothing, as is known in the art, comprises individual garments which are recognized as being “the same,” e.g., look and feel the same, are titled the same, are on the same rack in a row, or are advertised as one product in a catalog or online offering. Within the style of clothing may be or are various sizes. In some instances, variations of color may be considered the same style (e.g., a three-button, collared, polo shirt offered in blue or red). The cut and/or stitching within a style of garment is generally the same. In still further examples of style, the overall appearance of the garment may be recognizable as a single style by a merchant. Examples of various styles in t-shirts may be a “scoop neck” style, “tank top” style, and “A-shirt” style. For undergarments, each style may be recognizable based on cut, color, fabric, pattern, shape, frills, accessories, and the like. Thus, styles are generally sold as a single offering for sale, whereby a merchant provides, and a consumer makes selections from, a subset of features such as size or color.

As noted above, each style, in embodiments of the disclosed technology, comprises at least two sizes to choose from. A size is defined as a set of dimensions for a garment, based on a single set of pre-defined measurements, such as a predefined waist circumference or arm length. For example, according to the US standard, a “Misses size 6” has a waist of 25.5 inches and a bust of 34 inches, while a “Misses size 8” has a waist of 26.5 inches and a bust of 35 inches.

In embodiments of the disclosed technology, for each size (or at least two sizes), at least two selections of body type are provided. In an embodiment thereof, four body types are provided for each style and size combination. A body type of a garment, as used in embodiments of the disclosed technology, is a garment fitted for a person of a particular shape. Body types, as defined in embodiments of the disclosed technology, vary from one another based on proportionality of at least two elements of the body, e.g., the general or specific shape of the body and elements which make up that shape, such as hip size, leg opening circumference, waist, shoulders, buttocks, etc. The proportional differences for each body type include at least two of, such as three of, width, length, opening size, and padding of elements of each garment having a same size designation, with respect to each other. Embodiments of the disclosed technology may be specifically designed for undergarments, shirts, pants, women's clothing, dresses, or combinations thereof.

In embodiments of the disclosed technology, the body proportions of a person that are used in determining a body type are comprised of measurements of at least two of, or all of, the bust, shoulder, back, waist, hip, buttocks, and thigh elements of a body. It should, of course, be understood that any measurements of a person may be used to define or provide a garment having a specific body type. Thus, each body type comprises a specific set of such proportions, regardless of size of the garment, and this set is designed to be mass produced without a further tailoring requirement. A garment, in embodiments of the disclosed technology, comprises both a defined size designation and defined body type designation, and a person of ordinary skill in the art, e.g., a consumer, would be able to recognize, for example, that a size “6-Apple” camisole is one which has a wider opening near the top, wider back, short waist rise, and narrow hips with extra firm sides. In short, a garment of any given size is designed to more comfortably fit a person's specifically shaped body without the need for (further) custom manufacturing or tailoring of clothing for a specific individual, and may be applied to any type of garment known in the art.

The disclosed technology will become clearer in light of the description of the figures.

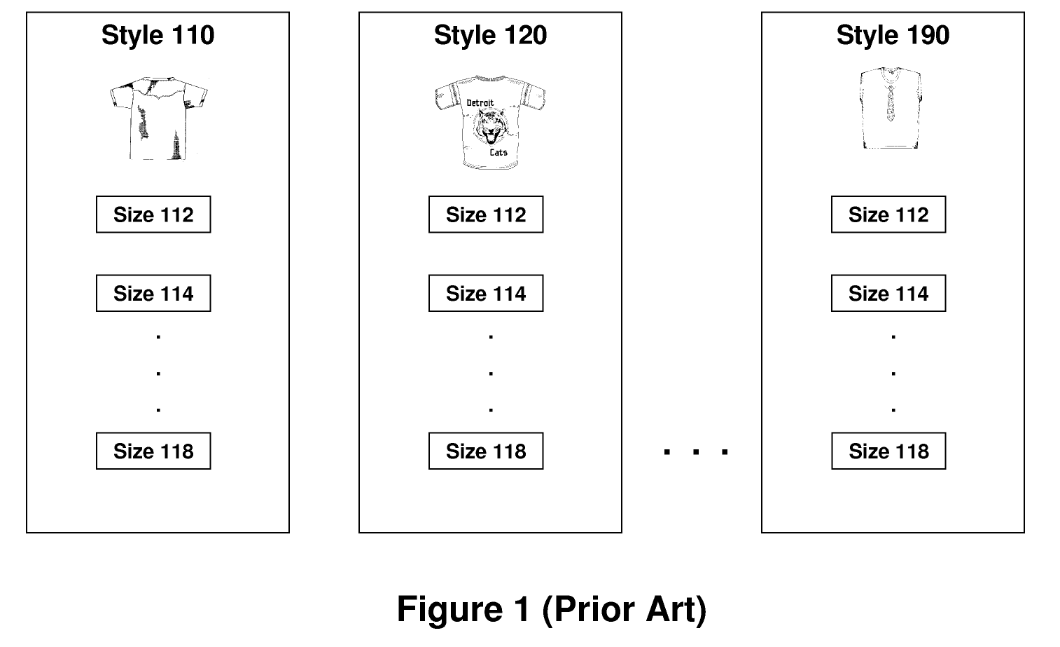

FIG. 1 shows a high level chart of a prior art method for offering a line of clothing for sale based on size. The figure shows an offering of different styles of t-shirts that vary in appearance and cut. When t-shirts are shown in FIG. 1, it should be understood that, referring to the figures in general, any styles of clothing and specific garments thereof are encompassed in the embodiments of the disclosed technology. The first t-shirt 110 shows one particular style. The second t-shirt 120 shows a t-shirt style different from the first 110. Any number of different styles can be offered up until the last style 190. For each style, an article of clothing is offered in a particular size 112, such as for example, US standard size 6, or medium, as is known in the art. The article of clothing may be offered in a larger or smaller size, such as size 114. Size 114 may be, for example, US standard size 8 or large. There can be any number of variations of the size of a particular style up to a size 118. While this form of providing a line of clothing takes into consideration the size and the tastes of a customer, it fails to consider the person's physical proportions.

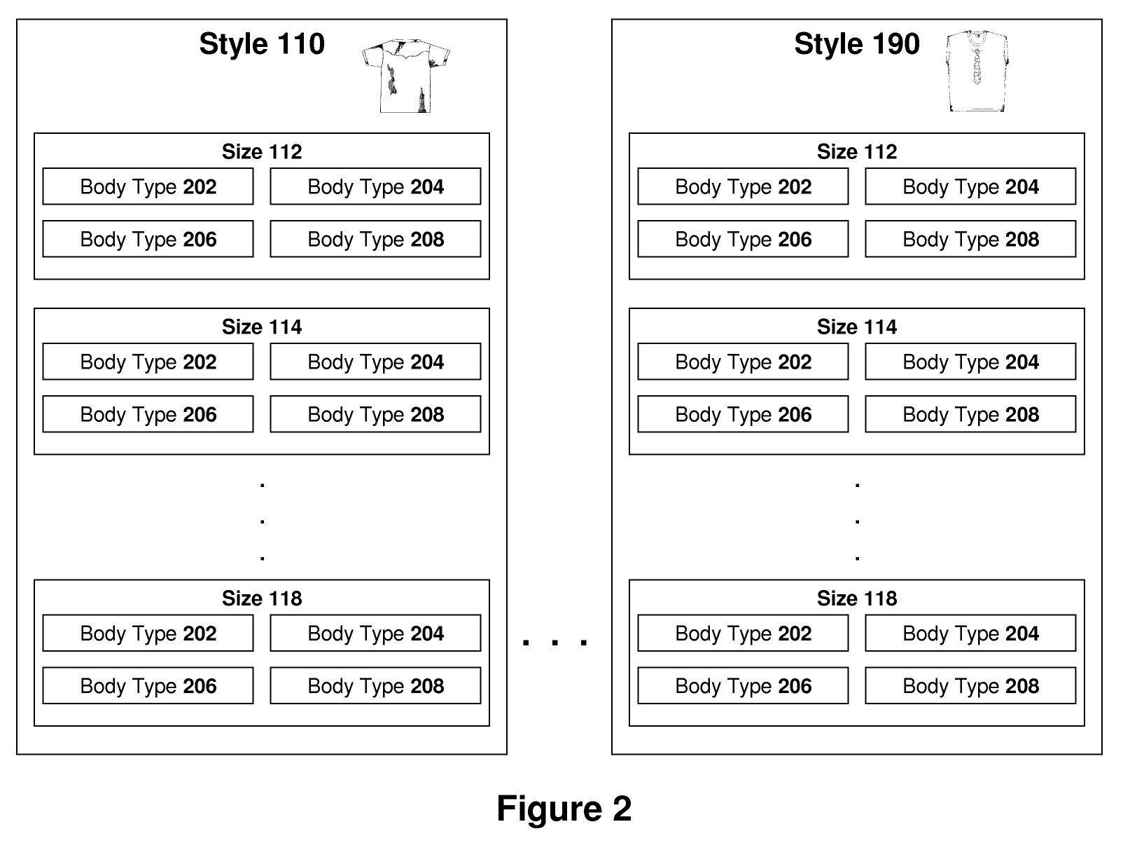

FIG. 2 shows a high level chart of a method of offering and/or manufacturing a line of clothing for sale based on numerical size and body type in embodiments of the disclosed technology. The figure, in this example of an embodiment of the disclosed technology, shows different styles in the line of t-shirts that vary in appearance and cut. The first t-shirt 110 shows one particular style of t-shirt, the last t-shirt 190 shows a different style in t-shirts. It should be understood that an infinite number of styles of garment can be offered. For any of the particular styles, the line comprises at least two sizes for each style offered, such as size 112, size 114, and size 118. Any number of sizes for a particular style may be offered. In embodiments of the disclosed technology, for each size, or for at least one or two sizes, a choice of body type is provided/offered to the customer. For example, a garment or article of clothing within a line of clothing having a size 112 may be offered with any one of body types 202, 204, 206, or 208. Likewise, for size 114, each of the body types 202, 204, 206, and 208 is offered in the example shown in FIG. 2. While the size measurement remains constant, e.g., for a person who is traditionally a U.S. standard size 6, at least two body types 202, 204, 206 and 208 for each size differ from each other in physical proportions so as to fit a customer's specific body type (e.g., shape). A body type is a broad classification of the shape of a person's body based on elements of the body, e.g., an hourglass-shaped body. An article of clothing having a size based on body type is designed to fit a person having such a specific body type, based on a plurality of proportionalities of elements of such a garment. Any number of body types for any number of body shapes may be offered, such as two, three, four, or six body type/shape selections. Offering a customer these options allows the customer to more accurately know if a selected garment of clothing will fit comfortably, match his/her taste, and will more likely be tailored to the requirements of his/her particular body than prior art clothing.

In an example of embodiments of the disclosed technology, body types of a style of clothing (within a particular size) are differentiated by and defined as differing in at least two or more measurements, sizes, or shapes of the bust and shoulders 310, the back 320, the waist 330, the hips 340, the buttocks 350, and/or the thighs 360. The body type of a person is measured by comparing the proportionality of physical aspects of one body type to the proportionality of the physical aspects of another body type or of other elements of the body. For example, when offering four body types, one body type, though sold/labelled as the same size as the rest, may have a waist 330 with greater circumference than the rest, and another body type may have thighs 360 with a longer rise and thinner opening than the others. Still other features of a person's body may be differentiated from one another to define body types in embodiments of the disclosed technology.

In embodiments of the disclosed technology, the bust and shoulders 310 is a section of a person's torso just below the armpits. The back 320 of a person is the lower section of a person's torso just above the pelvic region on the opposite side of a person's stomach around the base of the spine. The waist 330 is the narrowing of the body between the ribs and the hips 340 (sometimes referred to as “high hips”). The hips 340 are both sides of the body just above the thighs 360. The buttocks 350 are the rounded area of the body located in the posterior of the pelvic region. The thighs 360 are the section of the body located between the pelvis and the knee. The body types provided as an example will also be categorized based on their waist-hip ratio, which is the circumference of the waist 330 compared to that of the hips 340. For example, a person with a waist 330 that is 80 centimeters in circumference and has hips 340 that are 100 centimeters in circumference would have a waist-hip ratio of 0.8. Waist-hip ratio will further be referred to as WHR. Again, for a given size, any one or a plurality of these measurements may vary based on body type, that is, a general shape of the body of an individual and the clothes in the line of clothing which is tailored to fit a person of that body type.

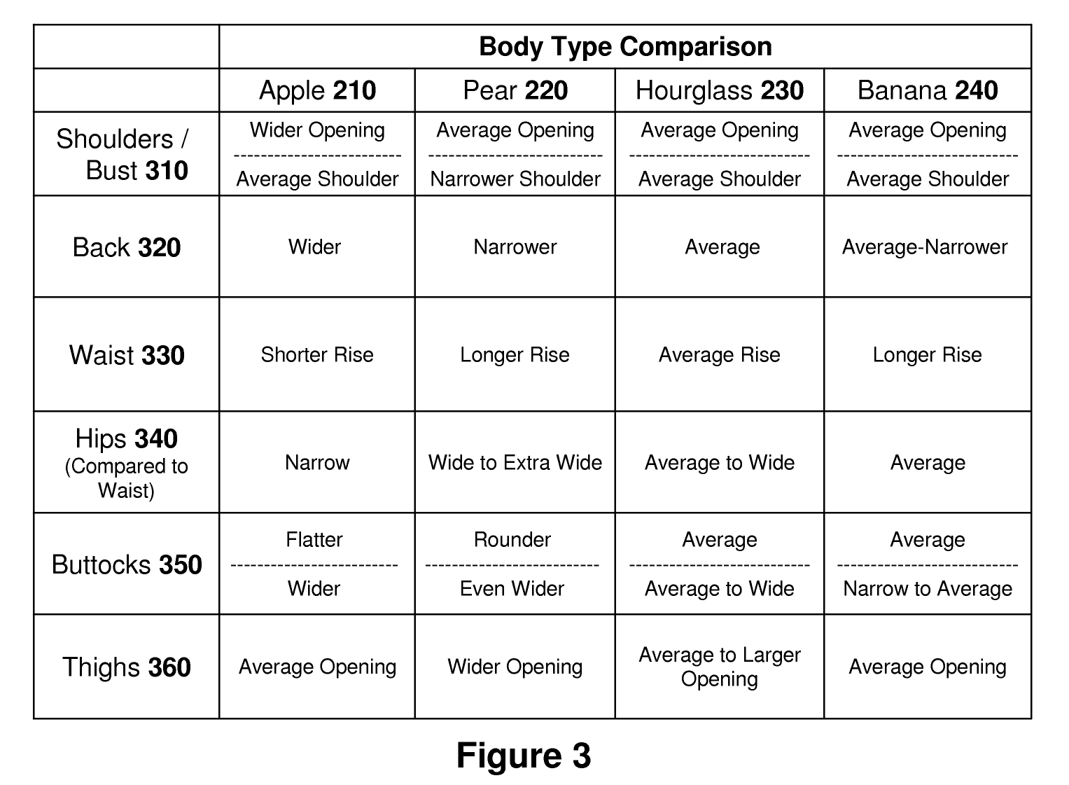

FIG. 3 shows a chart of body type features for garments in a line of clothing in embodiments of the disclosed technology. That is, garments in a clothing line with a specific style are differentiated by both same size and body type in embodiments of the disclosed technology. An embodiment of the disclosed technology is based on four body types, namely apple 210, pear 220, banana 230, and hourglass 240. While FIG. 3 shows a variety of different elements/attributes for each body type, it should be understood that to carry out embodiments of the disclosed technology, even one element/attribute which is differentiated between various body types, e.g., the buttocks, waist, etc., is contemplated and within the scope and spirit of the disclosed technology. Still further, multiple attributes or all attributes which characterize the body types of FIG. 3 may be varied in a body type offering for a garment having a particular style and same numerical size, etc.

In the example shown in FIG. 3, a first body type of a group comprising four different body types is apple 210. The apple 210 body type comprises garments made for people with a waist that is relatively large compared to the hips (WHR of 0.8 or higher) and a wider opening at the bust area than the other body types mentioned in FIG. 3. The high WHR can give the impression that the body has the roundness of an actual apple, or it can also give the appearance that the body is shaped like an upside down triangle. The apple 210 body type, or a person with an apple body type, generally comprises a broader bust and wider shoulders 310 compared to an average width of people and/or compared to the other body types referred to in FIG. 3. (It should be understood that all indicators of a feature of a body type (e.g., shoulders 310) in FIG. 3 and described herein are compared to the average in the industry for a size, person, and/or other body types for the same-sized garment shown and described with reference to FIG. 3, and may be further compared based on specific comparison language provided herein below.

The apple 210 body type has a wider circumference at the garment opening compared to others. The back 320 of the apple 210 body type is wider than the backs 320 of the other body types shown in FIG. 3. The apple 210 body type comprises a shorter and larger waist 330 and further comprises a shorter rise around the waist 330 than the other body types. Rise refers to the measurement starting at the navel, going between the legs and back up to the back of the waist. An embodiment of the disclosed technology has a smaller hip measurement than the average measurement of the other body types mentioned. The hips 340 are narrow when compared to the waist 330 and an apple 210 body type comprises a WHR of 0.8 or higher. The buttocks 350 of the apple 210 body type has less curvature and wider width than the other body types mentioned in this example. In an embodiment of the disclosed technology, the garment has less fabric for smaller buttock area coverage. The thighs 360 of a garment having a style and apple 210 body type are proportionate to the rest of the person's body and would be average in size when compared to the thighs of the other body types listed in this example. The thighs of an apple body type would have an average leg opening when compared to other body types. A second body type, as shown in FIG. 3, is the pear 220 body type. A pear 220 body type comprises a longer and smaller waist 330 and a smaller bust and shoulders 310 in proportion to the hips 340 of the body, when compared to the proportions of the other body types mentioned. Such a body may be described as having a shape similar to a pear fruit or an acute isosceles triangle with a narrower top region and a wider bottom region. In this example, the bust and shoulders 310 for a pear-shaped 220 body has a narrow bust and shoulders in proportion to the body and a narrower circumference at the garment's opening compared to the other body types shown and described in FIG. 3. Still further, a back 320 for a pear 220 may have a narrower width. The waist 330 is small in proportion to the hips 340 when compared to the other body types of FIG. 3. The WHR for a pear 220 body type is less than 0.8. The pear 220 body type may further comprise a longer waist 330 coverage, e.g., a higher rise. The hips 340 are extra wide in proportion to the waist 330, when compared to the proportions of the other body types mentioned in this example. The buttocks 350 section of the garment has a fuller bottom than other body types mentioned in this example by having both a broader width and a greater curvature. A garment of a pear body type further has extra fabric for larger buttock area coverage, compared to other body types. The thighs 360 are larger in proportion to the hips and have larger leg openings when compared to the other body types mentioned. A third body type in the example of FIG. 3 is the body type of hourglass 230. The hourglass 230 body type receives its name for resembling a shape similar to that of an hourglass time measuring device, e.g., two isosceles triangles having vertices meeting in the middle. An hourglass body may be described as comprising a bust 310 that is close to, or is the same size as, the hips 340, and a waist 330 that is smaller than both the bust 310 and the hips 340. An hourglass 230 body type further has a WHR less than 0.8. The bust and shoulders 310 are average in proportion to the body, when compared to the different body types in this example. Hourglass 230 body types comprise an average circumference at the garment opening and an average shoulder length when compared to other body types mentioned in this example and the accepted average for garments within the art. The back 320 of an hourglass 230 may have a proportionately narrower width when compared to the other body types listed in this example. Still further, the hourglass 230 body type comprises a smaller than average waist 330 when compared to the waists of other body types and/or the average known in the art. Still further, in embodiments of the enclosed technology, the width of the hips 340 are average to large when compared to the other body types in this example, and the hips 340 are wide when compared to the garment's waist 330. The WHR of an hourglass 230 body type garment is greater than 0.8. The buttocks 350 have an average curvature, average width, and average buttock region coverage when compared to the other body types mentioned in this example. The thighs 360 are of an average proportion and comprise an average-sized leg opening when compared to the proportion of the other garments mentioned in this example.

A fourth body type shown in the example of FIG. 3 is the banana 240 body type. In embodiments of the disclosed technology, where there are an apple 210 body type, a pear 220 body type, an hourglass 230 body type, and a banana body type, the banana 240 body type's bust 310, hips 340, and waist 330 are all close in size to each other when compared to the proportionality of the other body types mentioned in this example or the accepted average of garments within the art. Such a body type might be compared to having a body that resembles the shape of a banana (the fruit) or a generally rectangular shape. The bust and shoulders 310 comprise an average width, and the back 320 comprises a width that is average or narrower in proportion to its body, when compared to the other types of bodies mentioned in this example or the accepted average within the field. The banana 240 body type includes having a waist 330 with a longer rise than the other body types listed in this example, which may be between 1 and 9 inches less than the hips 340 or the bust 310 measurements of the banana 240 body type. The hips 340 are average to wider in proportion to the waist 330 when compared to the proportions of the other body types mentioned in this example. The buttocks 350 section of the garment comprises average curvature and an average width when compared to the other body types mentioned in this example. A garment comprising a banana 240 body type further comprises an average amount of fabric for average buttock area coverage when compared to the other body types mentioned in this example. The thighs 360 of a banana 240 body type comprise an average circumference of a leg opening when compared to the other body types described with reference to FIG. 3.

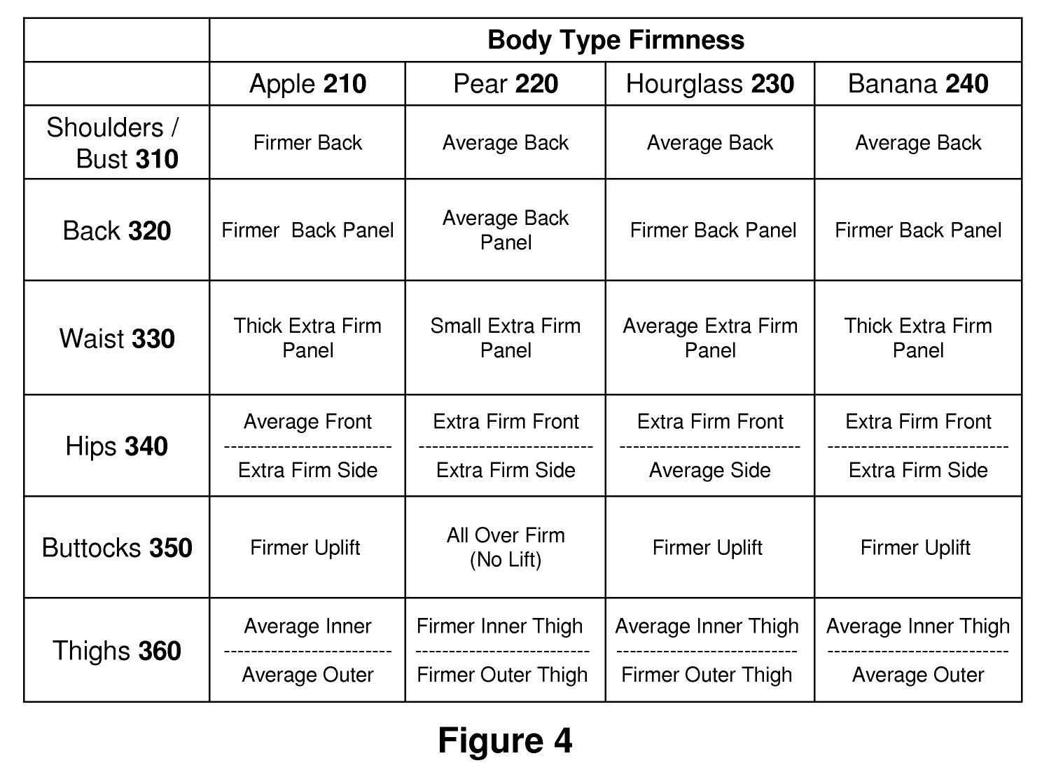

FIG. 4 shows a chart of body type firmness for garments in a line of clothing in embodiments of the disclosed technology. It should be understood that, while this example sets forth physical devices (garment styles and body type configurations) and a line of clothing that is further based on the firmness required in certain areas of garment-comprising specific body type shapes, this is by way of example and is not intended to be limiting. Other body types and other firmness configurations, varying in width and intensity of firmness, are contemplated and within the scope and spirit of the disclosed technology.

Each garment may be marked with indicia related to a specific body type. For example, an “apple garment” may be marked as being “apple” and have red color coding on a label or fixedly attached/made an integral part of the garment itself (e.g. sewn or knitted). The color coding may be in the form of a strip sewn into the inside of the waist. Likewise, pear may be marked with green color coding, banana with yellow, and hourglass with black.

Referring again to the apple 210 body type: In an embodiment of the disclosed technology, the shoulders 310 of the apple 210 body type comprise firmer back support and a wider opening at the bust area (compared to other body shapes disclosed in FIGS. 3 and 4) and the back 320 of the apple 210 body type comprises a firmer back panel than the other body types mentioned herein and/or the accepted average of firmness for garments known in the art. The waist 330 comprises an extra firm front panel around the abdomen (again, when compared to other body types herein and/or the accepted average firmness for the abdominal area known in the art). The hips 340 of the apple 210 body type comprise extra-firm side panels at the upper part of the hips (high hips) 340 to give the body of a wearer of such a garment a desired shaping, but hips 340 of such a garment comprise no extra control panels. A hip control panel provides the same type of support as a abdomen control panel in that it compresses the excess fat to create a more defined waist, though at the sides of the body. The buttocks 350 may comprise firmer uplift panels under the buttocks 350 to lift and give the buttocks a desired shape. The thighs may comprise average inner firmness and average outer firmness when compared to the other body types or the accepted average in the art of clothing.

Regarding firmness of elements of a garment made in the body type of pear 220, the pear body type has an average firmness for the shoulders 310 and the back 320 when compared to the accepted average firmness in the art or to the other body types mentioned herein. The pear 220 body type is comprised of a longer and smaller waist 330 that has an average firmness back panel and the hips 340 may comprise an extra-firm front panel and an extra-firm side panel (“saddlebags”). In an embodiment of the disclosed technology, the buttocks 350 comprise a fuller bottom and an all around average firmness, and the thighs comprise a firm panel on both the inner and outer thighs 360.

Referring now to the firmness of elements of the hourglass 230 body type elucidated in FIG. 4, this body type comprises, in embodiments of the disclosed technology, average firmness of a rear portion of the bust and shoulders 310, a firmer back panel for the back 320, and an extra firm panel of average thickness for the waist 330 when compared to the other body types mentioned in this example or the accepted average firmness in the art of clothing. The hips 340 of the hourglass 230 body type, in embodiments of the disclosed technology, comprise an extra-firm front panel at the abdomen and average firmness at the sides, as compared to the other body types mentioned in this example or the accepted average firmness within the art. The buttocks 350 comprise firmer uplift panels to lift and give a desired shape to the buttocks of such a garment and to the wearer, and the thighs 360 comprise firmer outer thigh side panels to control the outer thigh, as well as average control panels for inside thigh gussets when compared to the accepted average firmness within the art or compared to the other body types mentioned in this example.

Referring now to the firmness of elements of the banana 240 body type as shown in FIG. 4, this body type comprises, in embodiments of the disclosed technology, average thickness in the back around the bust and shoulders 310 area. Still further, the back area comprises a firmer back panel, and the waist comprises a thicker extra-firm panel when compared to the other body types mentioned within this example or the accepted average in the art. In embodiments of the disclosed technology, the hips 340 comprise an extra-firm front rectangular shaped waist panel at the abdomen and extra-firm side panels at the high hip 340 area for shaping. Further, a firm uplift panel under the buttocks 350 to lift and give shape to the body is present in embodiments. The outer thigh 364 and inner thigh 362 comprise average control panels and gussets when compared to the other body types mentioned in this example or the accepted average firmness in the art.

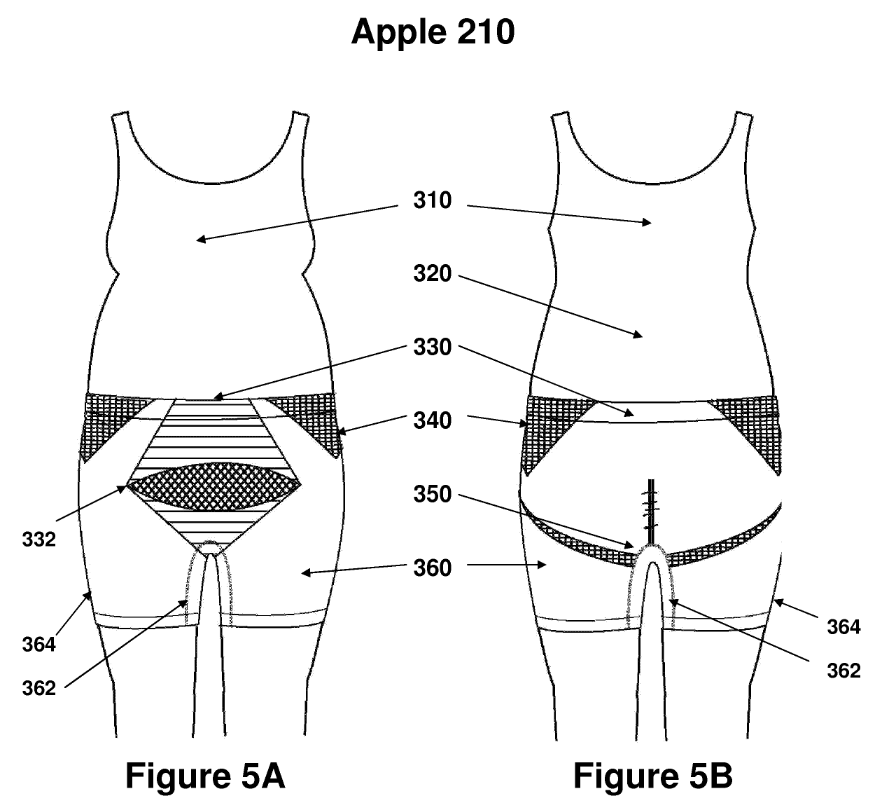

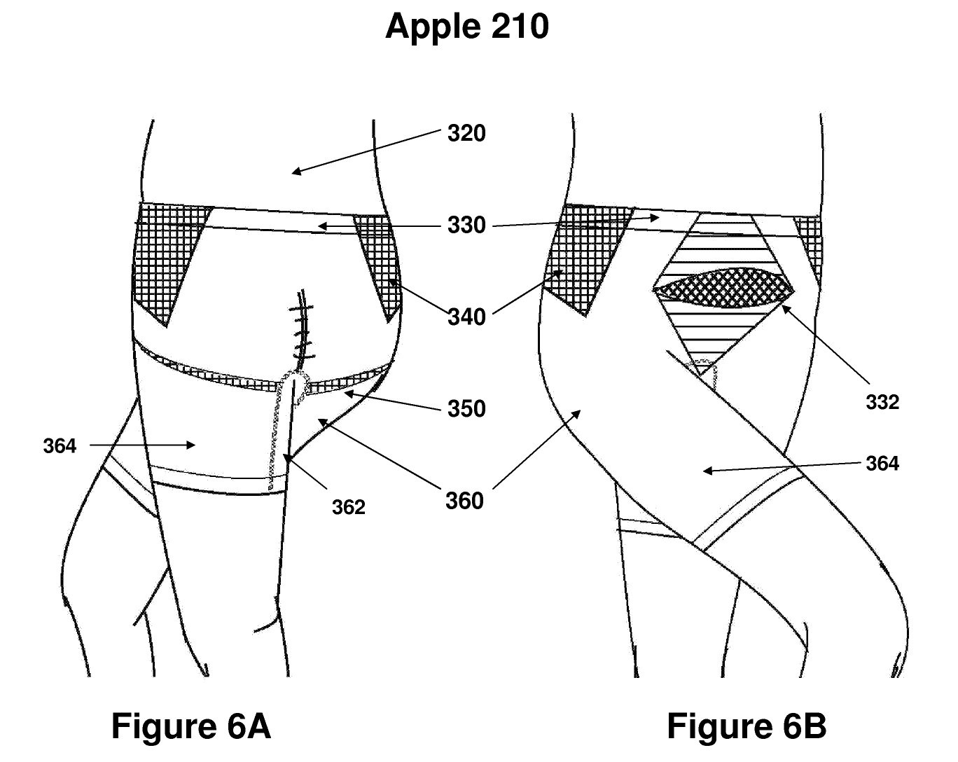

FIG. 5A is a drawing of a front view of a garment comprising an apple body type in an embodiment of the disclosed technology. FIG. 5B is a drawing of a back view of a garment comprising an apple body type in an embodiment of the disclosed technology. FIG. 6A is a drawing of a back, side view of a garment comprising an apple body type in an embodiment of the disclosed technology. FIG. 6B is a drawing of a front, side view of a garment comprising an apple body type in an embodiment of the disclosed technology. The apple body type 210 has been shown and described with reference to the previous figures. A wide extra firm panel at the abdomen 332 around the waist 330 of an apple-shaped garment is seen in the figures. The outer thigh 364 lacks a control panel, and the inner thigh 362 comprises average thickness when compared to the thickness of the other body types mentioned herein and/or the accepted average firmness within the art.

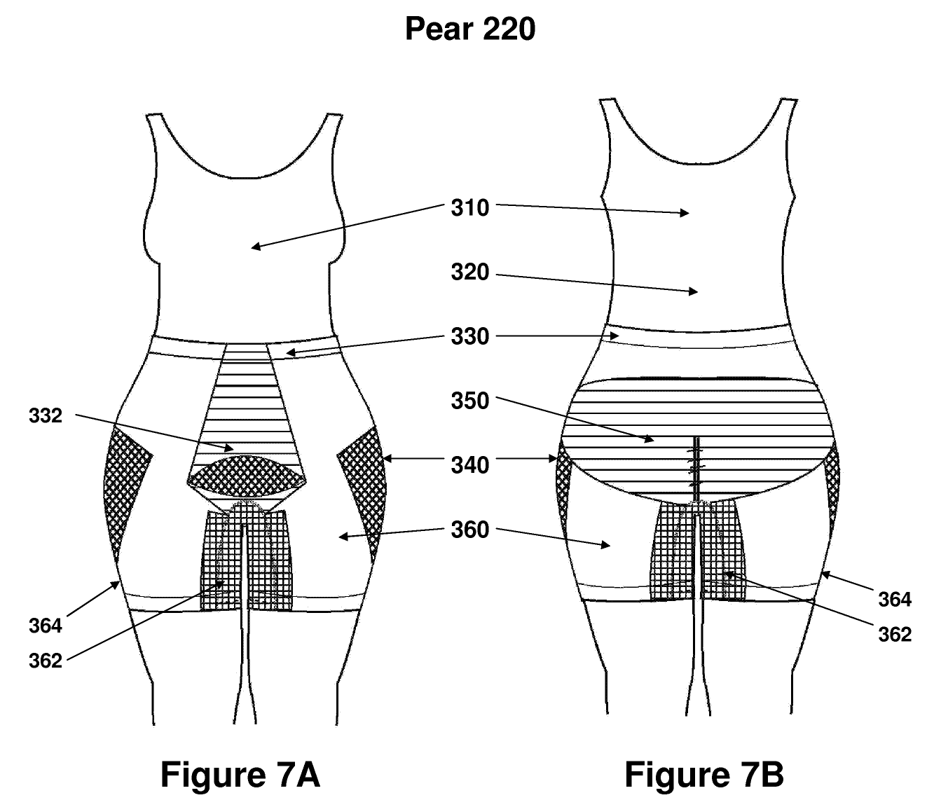

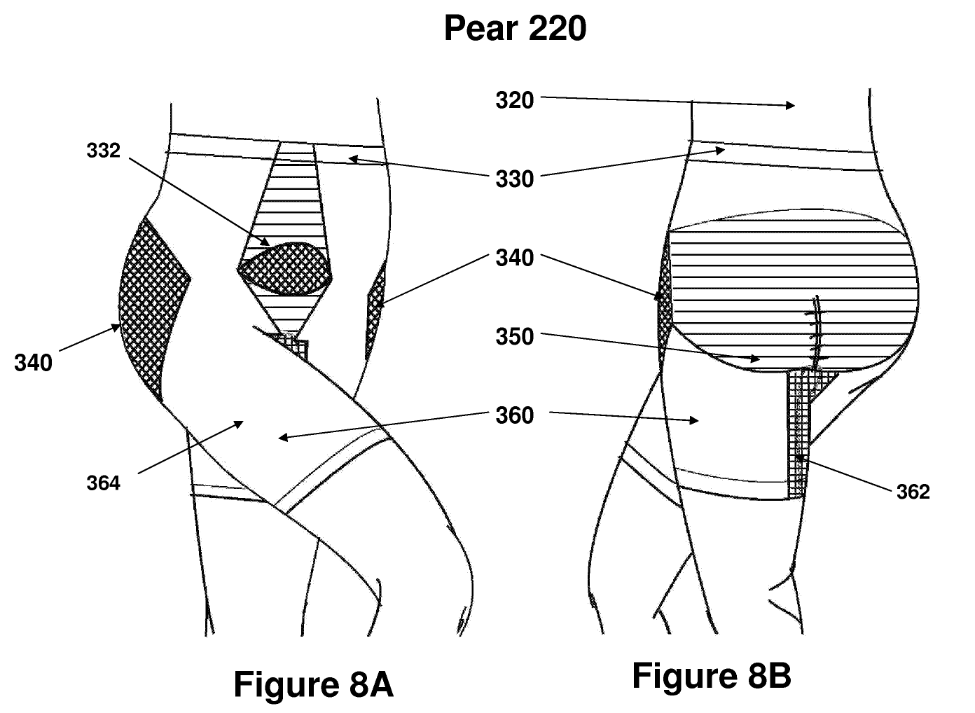

FIG. 7A is a drawing of a front view of a garment comprising a pear body type in an embodiment of the disclosed technology. FIG. 7B is a drawing of a back view of a garment comprising a pear body type in an embodiment of the disclosed technology. FIG. 8A is a drawing of a front, side view of a garment comprising a pear body type in an embodiment of the disclosed technology. FIG. 8B is a drawing of a back, side view of a garment comprising a pear body type in an embodiment of the disclosed technology. In this embodiment, the body types have firm control inner thigh 362 gussets and firm panels to control the outer thighs 364.

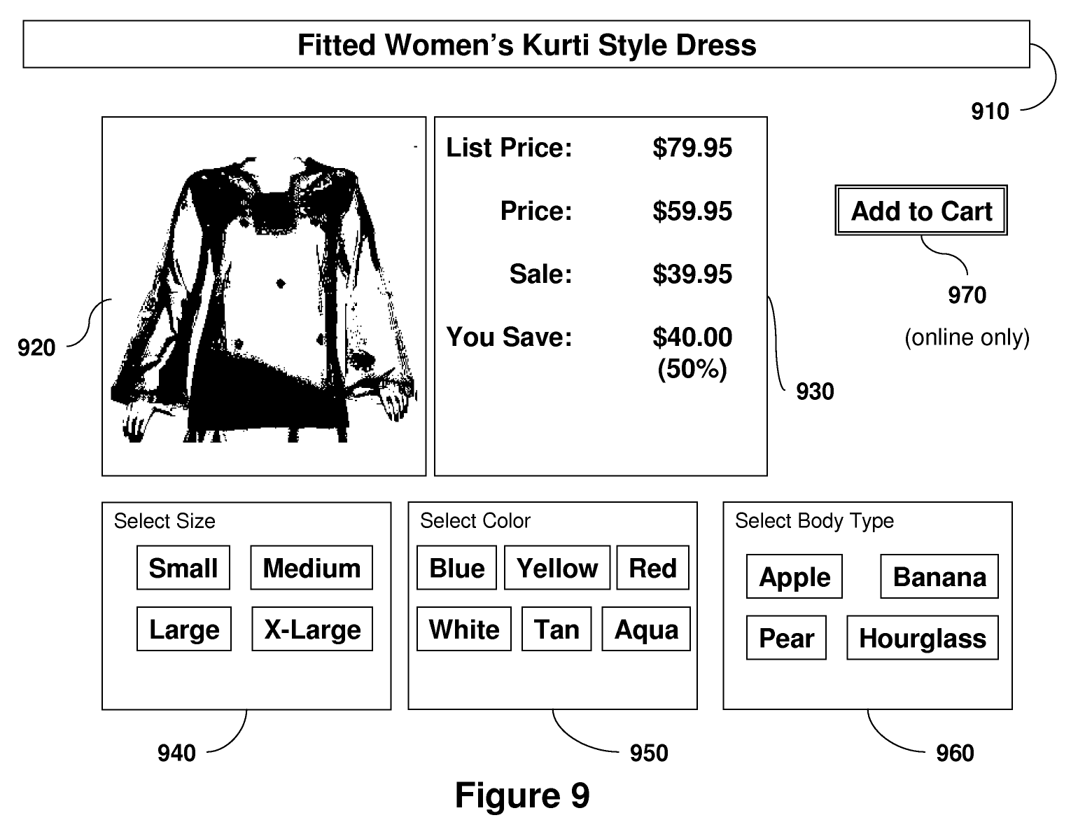

FIG. 9 shows an example of a method of offering a clothing style comprising a body type selection in an embodiment of the disclosed technology. This interface, in the embodiment shown in the figure, shows a method of offering a line of clothing for sale, including a title of the garment offered 910, a picture of the garment 920, and the listed price of the cost of the garment 930. The method shown for this example offers three buttons, which may be radio buttons, to make selections on the garments. Any method of indicating a selection on the part of a user may be employed, such as those known in the art of print catalog order forms, web order forms, and the like. In the example shown, the “select size” button 940 allows the customer to choose the desired numerical size of the garment from a given selection, and the “select color” button 950 allows the customer to choose the color of the garment desired. In an embodiment of the disclosed technology, a choice of color may be interchanged with, or added to, any other selection of styles. The “select body type” button 960 gives the customer a selection that is novel compared to the prior art, whereby the customer may choose one of any number of body types available for purchase. In the example shown, the customer can choose from a group of body types selected from the group consisting of four body types, and the body types from the group consisting of apple, pear, hourglass, and banana may be selected for purchase. Once the customer or purchaser has selected desired options, the item is added to an online shopping cart by way of the “Add to Cart” button 970. Shopping carts are known in the art and in the method of selling such an item, and adding an item to the shopping cart may reserve the item customers have selected according to their body type, and where selected/available for selection, also according to the size and/or preferred color for later purchase. It should, of course, be understood that the selection of color and size represents examples of further selections, in addition to body type, which may be selected by a user and offered by a merchant to aid in the sale of a desired garment based on style, size, and/or body type. Any indicator/selector may be used to help narrow a selection of a garment based on the line of clothing, style, size, etc. in which the garment belongs.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

I claim:

1. A method of offering a line of clothing for sale comprising:
providing a selection of at least two styles in said line;
providing a selection of at least two sizes for each said style;
providing a selection of at least two body types for each said size; and
selling a garment to a purchaser based on a style, size, and body type.

2. The method of claim 1, wherein said at least two body types are selected from the group consisting of apple, pear, hourglass, and banana.

3. The method of claim 1, wherein said at least two body types are four body types.

4. The method of claim 1, wherein:
a first body type comprises a wider opening at a bust area than other said body types;
a second body type comprises a longer and smaller waist than said first body type; and
said second body type comprises a fuller bottom than other said body types.

5. A method of manufacture of a line of clothing comprising:
manufacturing said line of clothing in at least two styles;
manufacturing at least two sizes of each said style;
manufacturing at least two clothing body types for each said style.

6. The method of claim 5, wherein said at least two body types are selected from the group consisting of apple, pear, hourglass, and banana.

7. The method of claim 5, wherein said at least two body types are four body types.

8. The method of claim 7, wherein:
a first body type comprises a wider opening at a bust area than other said body types;
a second body type comprises a longer and smaller waist than said first body type; and
said second body type comprises a fuller bottom than other said body types.

9. A line of clothing comprising:
at least two styles;
at least two sizes for each said style;
at least two body types for each said size and said style.

10. The line of clothing of claim 9, wherein said at least two body types are selected from the group consisting of apple, pear, hourglass, and banana.

11. The line of clothing of claim 9, wherein said at least two body types are four body types.

12. The method of claim 11, wherein:
a first body type comprises a wider opening at a bust area than other said body types;
a second body type comprises a longer and smaller waist than said first body type; and
said second body type comprises a fuller bottom than other said body types.

13. Articles of clothing, said articles designed in a same style and consisting of a same numerical size, and each of at least three articles comprise a different one of at least three body types, whereby:
a first body type comprises a wider opening at a bust area than said other said body types;
a second body type comprises a longer and smaller waist than said first body type; and
said second body type comprises a fuller bottom than other said body types.

14. The articles of clothing of claim 13, wherein said first body type further comprises a shorter and larger waist than at least two other said body types.

15. The articles of clothing of claim 13, wherein said first body type further comprises a smaller hip measurement than at least two other said body types.

16. The articles of clothing of claim 13, wherein said second body type comprises larger leg openings than at least two other said body types.

17. The articles of clothing of claim 13, wherein said at least three articles are four articles each comprising one of four different body types.

18. The articles of clothing of claim 17, wherein said four body types are apple body type, pear body type, hourglass body type, and banana body type.

19. The articles of clothing of claim 17, wherein articles comprising a said second body type and a said fourth body type comprise a waist with a longer rise than said first and third body types.

20. The articles of clothing of claim 17, wherein said articles are undergarments.

21. The articles of clothing of claim 13, wherein indicia is an integral part of each article of clothing and said indicia is based upon a body type of each said article.
